(19) United States
(12) Patent Application Publication
(10) Pub. No.: US 2024/0365829 A1
(43) Pub. Date: Nov. 7, 2024

(54) Process for Making Popping Boba for Stabilizing Spherification and Improving Taste

(71) Applicant: Gary Tsai, New Taipei City (TW)

(72) Inventor: Gary Tsai, New Taipei City (TW)

(21) Appl. No.: 17/985,156

(22) Filed: Nov. 11, 2022

(51) Int. Cl. A23L 29/256; A23P 20/10; A23P 20/17

(52) U.S. Cl. CPC A23L 29/256; A23P 20/105; A23P 20/17

(57) ABSTRACT

A process for making popping boba comprises a primary spherification by dropping flavored liquid containing calcium salt into a sodium alginate bath for producing a semi-finished boba ball with thin shell or skin; and a reinforcing spherification by dumping the semi-finished boba ball as made aforementioned into a calcium salt bath for forming a reinforcing thin layer of calcium alginate on the semi-finished boba ball for producing a finished boba ball, thereby stabilizing the spherification and improving the taste or texture of the popping boba.

### BACKGROUND OF THE INVENTION

Conventional popping boba is made by using spherification process by reacting sodium alginate and calcium chlorides. The spherification process includes two versions, namely direct spherification and reverse spherification.

In direct spherification, a gelling solution of sodium alginate is mixed directly with the chosen liquid such as juice or food and then dropped in calcium chloride and water to form a popping boba with thin gel shell.

In reverse spherification, fitting liquid with calcium lactate is dumped in a sodium alginate bath to form popping boba with a thick shell for covering the liquid therein.

However, the popping boba made from direct spherification process may be easily breakable and should be consumed immediately. While the popping boba made from the reverse spherification process has a thick shell, which may remain as a solid shell in the user's mouth, causing unpleasant feeling when squeezed.

The present inventor has found the drawbacks of the conventional processes, and invented the present process for stabilizing spherification of the popping boba and also for improving the taste or texture for delightfully bitting the boba.

### SUMMARY OF THE INVENTION

The object of the present invention is to provide a process for making popping boba comprising a primary spherification by dropping flavored liquid containing calcium salt into a sodium alginate bath for producing a semi-finished boba ball with thin shell or skin; and a reinforcing spherification by dumping the semi-finished boba ball as made aforementioned into a calcium salt bath for forming a reinforcing thin layer of calcium alginate on the semi-finished boba ball for producing a finished boba ball, thereby stabilizing the spherification and improving the taste or texture of the popping boba.

### DETAILED DESCRIPTION

The present invention comprises: a primary spherification and a reinforcing spherification, which will be described in detail hereinafter:

### A. Primary Spherification:

Firstly, a flavored liquid (juice or food) containing calcium salt is prepared by mixing or blending the following ingredients: water, sugar, starch acetate, calcium lactate, flavoring agent including DL-malic acid, thickening agent including sodium carboxymethyl cellulose, β-carotene, and sodium alginate.

Now, a sodium alginate bath is prepared by dissolving or diffusing a sodium alginate in water by a blender.

Then, the flavored liquid containing calcium salt is dropped into the sodium alginate bath for forming a thin shell of calcium alginate on the core with flavored liquid for producing a semi-finished baba ball.

The time as consumed longer for formation of the shell of calcium alginate is, the shell will be thicker. It is preferable to control the reaction time in the bath to be less than 2 minutes for a satisfactory cross-linking reaction of calcium ions in the calcium lactate with the sodium alginate to obtain the calcium alginate shell or skin. Once removing from the sodium alginate bath, the jellification will instantly stop to prevent production of too thick shell.

The shell will preliminarily protect the flavored liquid to prevent from immediate breakage of the semi-finished boba ball, which is further rinsed with clean water to remove any unreacted matters existing therein.

The calcium salt may include calcium lactate or other calcium-ion containing salts.

Thanks to the sodium carboxymethyl cellulose, sodium alginate and starch acetate added in the boba, the present invention may provide a tender flexible jelly-like taste or texture feeling when eaten or popped.

The juice or beverage in the flavored liquid may be selected from: litchi juice, mango juice, green tea, etc., but not limited in this invention.

### B. Reinforcing Spherification:

A calcium-containing bath is prepared by dissolving calcium salt containing calcium ions in a water bath.

The semi-finished boba ball as made as aforementioned is then dumped into the calcium-containing bath for circumferentially forming a reinforcing thin layer of calcium alginate on the semi-finished boba ball for further stabilizing the spherification, thereby producing a finished boba ball with thin thickness of the ball skin and improving the taste or texture when bitten or eaten. By reviewing the Step A as aforesaid when making the semi-finished boba ball by dropping the flavored liquid containing calcium ions into the sodium alginate bath, there is still a small amount of sodium alginate which may penetrate, due to osmosis, into the semi-finished ball. During the formation of calcium alginate shell in the Reinforcing Spherification process, the calcium ions in the calcium-containing bath will reach the shell of the semi-finished boba ball to further react, at the boundary or interface of the boba ball and the bath, with the residual sodium alginate remained in the ball. Therefore, the semi-finished ball is then further reinforced by a thin layer of calcium alginate on the surface for stabilizing the spherification. Like a patch used to seal “leakage” of clothing, the Reinforcing Spherification will compensate, reinforce and protect the boba ball as finished.

Since the thickness of the ball can be optimally controlled to be as thin as possible, it may not make a too-thick ball, which may deteriorate the taste or texture when eaten.

The boba ball as made in this invention may be mixed with a juice or beverage, which is then packed to be a cup, a bottle, or a container for convenient use, storage or handling.

The present invention may be further modified without departing from the spirit and scope of the present invention.

I claim:

1. A process for making popping boba comprising a primary spherification by dropping flavored liquid containing calcium salt into a sodium alginate bath for producing a semi-finished boba ball with thin shell; and a reinforcing spherification by dumping the semi-finished boba ball as made into a calcium salt bath for forming a reinforcing thin layer of calcium alginate on the semi-finished boba ball for producing a finished boba ball, thereby stabilizing the spherification and improving the taste or texture of the popping boba.

2. The process of claim 1, wherein said primary spherification comprise:
(1) preparing a flavored liquid (juice or food) containing calcium salt by mixing or blending the following ingredients: water, sugar, starch acetate, calcium lactate, flavoring agent including DL-malic acid, thickening agent including sodium carboxymethyl cellulose, β-carotene, and sodium alginate;
(2) preparing a sodium alginate bath by dissolving or diffusing a sodium alginate in water by a blender; and
(3) dropping the flavored liquid containing calcium salt into the sodium alginate bath for forming a thin shell of calcium alginate on a core with flavored liquid for producing a semi-finished baba ball.

3. The process of claim 2, wherein said calcium salt includes calcium lactate and calcium-ion containing salts.

4. The process of claim 1, wherein said reinforcing spherification comprises:
preparing a calcium-containing bath by dissolving a calcium salt containing calcium ions in a water bath; and
then dumping the semi-finished boba ball into the calcium-containing bath for circumferentially forming reinforcing thin layer of calcium alginate on the semi-finished boba ball for further stabilizing the spherification.
